(19) United States
(12) Patent Application Publication
(10) Pub. No.: US 2007/0261719 A1
(43) Pub. Date: Nov. 15, 2007

(54) RETRACTABLE FLUID DIRECTING SYSTEM

(76) Inventors: James Amato, New Britain, PA (US); Derek Hoffman, Flourtown, PA (US)

Correspondence Address: DOVAS LAW P.C., 307 BAINBRIDGE STREET, PHILADELPHIA, PA, 19147, US

(21) Appl. No.: 11/552,964

(22) Filed: Oct. 25, 2006

Related U.S. Application Data
(60) Provisional application No. 60/800,494, filed on May 15, 2006.

(51) Int. Cl. B08B 3/00; B08B 3/12

(52) U.S. Cl. 134/34; 134/184; 134/198; 134/56 R

(57) ABSTRACT

A system for cleaning and sanitizing a food preparation area is provided. The system includes a retractable hose device, including a hose and a device for retracting the hose, and a fluid directing nozzle connected to the hose. A proportioning device is connected to the hose which includes a first input for receiving one or more of a cleaning agent and a sanitizing agent, and a second input for connection to a supply of diluent.

### CROSS REFERENCE TO RELATED APPLICATION(S)

This application claims the benefit of U.S. Provisional Patent Application No. 60/800494, filed May 15, 2006 which is incorporated by reference as if fully set forth.

### BACKGROUND

Maintaining sanitary conditions at food processing and preparation stations in restaurants, stores and other food businesses is a serious matter requiring diligent attention. Food contamination is frequently the cause of illness among consumers including restaurant patrons and market shoppers alike. The potential liability resulting from a customer's illness has given food proprietors a strong incentive to maintain clean and sanitary conditions in their food processing operations.

Food preparation areas in restaurants, stores and factories are often provided with a sanitizing solution contained in a spray bottle to be applied by a worker to food preparation surfaces between preparation sequences and/or at periodic intervals. The sanitizing solution is typically formed by combining a concentrated sanitizing agent and water. Often the combination of sanitizing agent and water is performed on site near where the food preparation is taking place. For example, individual spray bottles may be refilled with solution by a food preparer between food preparation activities.

Refilling of spray bottles is time consuming, and the effort involved therein may cause workers to under utilize the sanitizing solution to avoid the inconvenience of the refilling process. Such failure to use sufficient amounts of sanitizing solution may result in unsafe conditions. Accordingly, there is a need to provide a system and method for delivering sanitizing solution to a food preparation area which is simple and which does not consume a significant amount of time.

### SUMMARY

The present invention provides a system for cleaning and sanitizing a food preparation area. The system includes a retractable hose device, including a hose and a device for retracting the hose, and a fluid directing nozzle connected to the hose. A proportioning device is connected to the hose which includes a first input for receiving one or more of a cleaning agent and a sanitizing agent, and a second input for connection to a supply of diluent.

The present invention further provides a combination food preparation area and cleaning and sanitizing system including a food preparation area and a cleaning and sanitizing system positioned in proximity to the food preparation area. The cleaning and sanitizing system includes at least one retractable hose device, including a hose and a device for retracting the hose, and a fluid directing nozzle connected to the hose. A fluid proportioning device is connected to the hose for connection to a diluent supply.

The present invention further provides a method of cleaning and sanitizing a food preparation area. The method includes providing a retractable hose device including a hose and a device for retracting the hose, in proximity to a food preparation area. A fluid directing nozzle and a fluid proportioning device is provided connected to the hose. One or more of a cleaning agent and a sanitizing agent is provided to the fluid proportioning device. A supply of diluent is connected to the fluid proportioning device. The cleaning agent or the sanitizing agent is proportioned with the diluent supply using the fluid proportioning device to create one or more of a cleaning solution and a sanitizing solution. The hose is at least partially extended from a retracted position, and solution is discharged through the fluid directing nozzle toward the food preparation area.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a perspective view of a food preparation area including a cleaning and sanitizing system according to a preferred embodiment of the present invention.

FIG. 2 is a perspective view of a blending system of the cleaning and sanitizing system of FIG. 1.

FIG. 3 is a front view of the blending system of FIG. 2 with a cutaway portion.

FIG. 4 is a front view of a cleaning and sanitizing system according to another preferred embodiment of the present invention.

FIG. 5 is a diagram showing a method of cleaning and sanitizing a food preparation area according to a preferred embodiment of the present invention.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

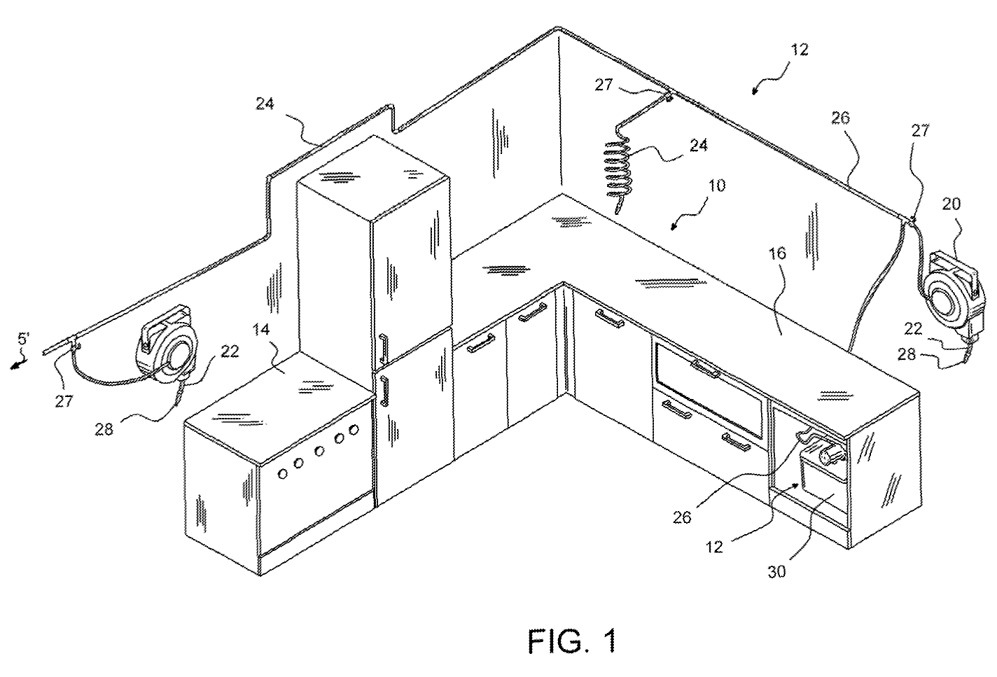

Referring to FIG. 1, a food preparation area 10 including a system for cleaning and sanitizing 12 according to a preferred embodiment of the present invention is shown. The cleaning and sanitizing system 12 includes retractable hose devices including retractable hose reels 20 with hoses 22 and a self-retracting coil hose 24. A blending system 30 is connected to the hoses 22, 24 via connection lines 26 for providing the hoses 22, 24 with a liquid solution of cleaning agent and/or sanitizing agent and diluent for dispensing in the food preparation area 10. The food preparation area 10 includes a plurality of food preparation surfaces 12 including cooking surfaces 14 and non-cooking surfaces 16.

The retractable hose reels 20 each preferably include a retractor with a spring mechanism for automatically retracting the hose. Alternatively, the hose reels 20 can also include a balancing mechanism to minimize operator effort during use of the hoses 22. The self retracting coil hose 24 can be extended when required and automatically returned to a storage position by inherent spring loading in the coil hose 24. Alternatively, any suitable retractable hose device can be provided including non-reel balancer arm devices or any device capable of removing a hose from a food preparation area or selectively positioning a hose within a food preparation area. The retractable hose devices 20, 24 can be ceiling or wall mounted or otherwise disposed within the food preparation area 10. While three retractable hose devices 20,24 are shown, it would be understood by those of skill in the art that any suitable number of retractable hose devices 20, 24 may be provided depending on a layout of the food preparation area and a number of food preparation workers present. As indicated by a solution flow direction arrow 5′ in FIG. 1, the connection lines 26 can extend to other retractable hose devices for servicing other portions of the food preparation area 10. Fluid shut off valves 27 are preferably provided to stop or limit a flow of fluid to the retractable hose devices 20, 24. A fluid directing nozzle 28 is connected to each of the hoses 22, 24 for dispensing the liquid solution onto the food preparation surfaces 14, 16, or in proximity thereto. The fluid directing nozzle 28 preferably provides an adjustable spray pattern conducive to satisfying user preferences and sanitary procedural requirements.

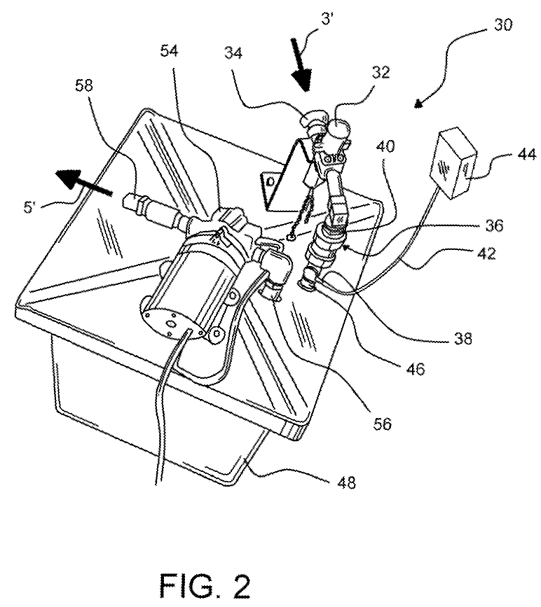

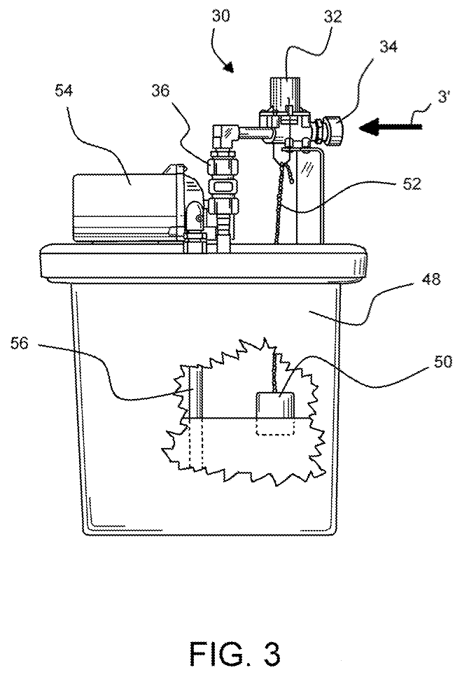

Referring now to FIGS. 2 and 3, the blending system 30 includes a control valve 32 having a connector 34 for connection to a supply of diluent, which is preferably water. A diluent flow arrow 3′ indicates a direction of flow of a supply of diluent input into the blending system 30. The control valve 32 regulates the flow of diluent to a blending device 36. The blending device 36 includes a first input 38 for receiving one or more of a cleaning agent and a sanitizing agent, and a second input 40 for receiving a flow of diluent. Preferably, during use a tube 42 is connected to the first input 38 which feeds cleaning or sanitizing agent from a refillable or replaceable container 44 to the blending device 36 (the tube 42, the container 44, and a power line are hidden in FIG. 3 for clarity). The blending device 36 is configured to provide a metered amount of one or more of the cleaning and sanitizing agent in a predetermined proportion to an amount of diluent flowing there through, and to discharge the resulting solution into a tank 48 through an output 46. Alternatively, any proportioning device capable of adding a metered amount of agent to a supply of diluent irrespective of any mixing process performed by the device. As stated herein, a proportioning device is defined as any device which can mix a metered amount of agent in a predetermined proportion to an amount of diluent flowing there through.

The tank 48 includes a float weight 50 for sensing a fluid level in the tank 48 and signaling the control valve 32 to open when a fluid level in the tank 48 sinks to a predetermined level thereby allowing diluent to flow to the blending device 36. The float weight 50 is connected to an adjustable chain 52 to actuate the control valve 32. When fluid level in the tank drops below a predetermined height releasing a buoyancy force on the float, the valve 32 is forced into an open position and fluid flow is permitted through the valve 32. Fluid flow is stopped when fluid level rises above the predetermined height in the tank 48 causing the valve 32 to automatically return to a closed position. A pump 54 draws solution from the tank 48 though a tube 56 and out an outlet 58 to provide pressurized solution to the connection lines 26, as shown by the solution flow arrow 5′. The pump 54 preferably is configured to operate at between about 25 and 100 psig at the required flow rates, and more preferably at about 60 psig. Alternatively, the sanitizing system 12 can be provided without a blend system having a tank and a control valve as shown, and a proportioning device can be attached directly to the lines 26. In such case, a pump can be omitted if pressure provided by line pressure of the diluent source is sufficient.

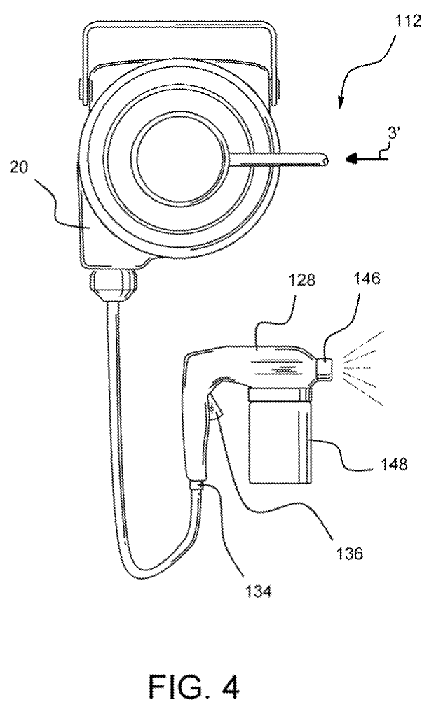

Referring to FIG. 4, a portion of a cleaning and sanitizing system 112 for use in a food preparation area according to another preferred embodiment of the present invention is shown. The cleaning and sanitizing system 112 can be implemented in a food preparation area, for example the food preparation area 10 shown in FIG. 1 in the same or similar manner as the sanitizing system 12, having a plurality of retractable hose devices devices 20, 24, each connected to a spray gun 128. The cleaning and sanitizing system 112 however does not utilize a blending device of the type described in system 12. Instead, the cleaning and sanitizing system 112 utilizes the spray gun 128 to blend a cleaning or sanitizing agent with a supply of diluent.

The spray gun 128 includes a reservoir 148 for storing cleaning or sanitizing agent which can be manually refilled. In use, a supply of pressurized diluent enters through a supply connection 134, and a trigger valve 136 is provided to allow passage of the diluent into a mixing chamber to blend a metered amount of agent with the diluent. Blended solution exits the spray gun 128 through a fan nozzle 146.

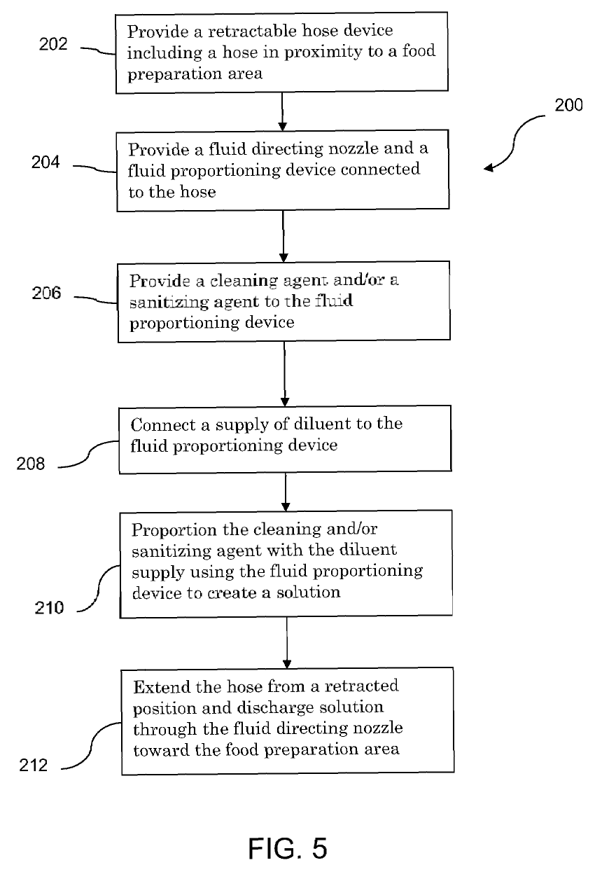

Referring to FIG. 5, a method 200 for cleaning and sanitizing a food preparation area according to a preferred embodiment of the present invention is shown. The method 200 includes providing one or more retractable hose devices, including a hose and a device for retacting the hose, in proximity to a food preparation area (step 202). A fluid directing nozzle and a fluid proportioning device are provided connected to the hose (step 204). A cleaning agent and/or a sanitizing agent is provided to the fluid proportioning device (step 206), and a supply of diluent is connected to the fluid proportioning device (step 208). Any suitable cleaning or sanitizing agent can be provided, for example quat sanitizer, degreaser, oven grill cleaner, window cleaner, furniture polish, all purpose cleaner, floor cleaner, or any water soluble cleaning/sanitizing chemical. Preferably, the supply of diluent is a pressurized water supply. The cleaning and/or sanitizing agent is proportioned with the diluent supply using the fluid proportioning device to create a solution (step 210). The hose is extended from a retracted position and solution is discharged through the fluid directing nozzle toward the food preparation area (step 212).

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A system for cleaning and sanitizing a food preparation area, the system comprising:
at least one retractable hose device including a hose and a device for retracting the hose;
at least one fluid directing nozzle connected to the hose; and
a proportioning device connected to the hose, the proportioning device comprising a first input for receiving at least one of a cleaning agent and a sanitizing agent and a second input for connection to a supply of diluent.

2. The system of claim 1, further comprising a pump connected to the hose for pressurizing a supply of fluid to the fluid directing nozzle.

3. The system of claim 1, wherein the proportioning device is a blending device.

4. The system of claim 1, further comprising:
a tank connected to the proportioning device for receiving the diluent and the at least one of the cleaning agent and the sanitizing agent; and
a pump connected to the tank and connected to the hose for supplying a solution of diluent and agent from the tank to the hose.

5. The system of claim 4, further comprising a control valve connected to the pump device for regulating a flow of the diluent and the at least one of the cleaning agent and the sanitizing agent into the tank, wherein the tank includes a level sensor connected to the control valve for sending a signal to the control valve to adjust a flow of the diluent and the at least one of the cleaning agent and the sanitizing agent into the tank depending on a fluid level in the tank.

6. The system of claim 1, wherein the retractable hose device comprises a reel which includes a spring for automatically retracting the hose.

7. The system of claim 1, wherein the retractable hose device is a self-retracting coil hose with the device for retracting the hose integrally formed therein.

8. The system of claim 1, wherein the fluid directing nozzle is an adjustable spray nozzle.

9. The system of claim 1, wherein the retractable hose device further comprises a balancing mechanism.

10. The system of claim 1, wherein the proportioning device is formed integrally with the fluid directing nozzle

11. A combination food preparation area and cleaning and sanitizing system comprising:
a food preparation area; and
a cleaning and sanitizing system positioned in proximity to the food preparation area and comprising at least one retractable hose device including a hose and a device for retracting the hose; a fluid directing nozzle connected to the hose; and a fluid proportioning device connected to the hose for connection to a diluent supply.

12. The combination of claim 11, wherein the food preparation area comprises at least one cooking surface.

13. The combination of claim 11, wherein the retractable hose device comprises a spring for retracting the hose.

14. The combination of claim 11, wherein the cleaning and sanitizing system further comprises:
a tank connected to the fluid proportioning device for receiving the diluent and the at least one of the cleaning agent and the sanitizing agent; and
a pump connected to the tank and connected to the hose for supplying a solution of diluent and agent from the tank to the hose.

15. The combination of claim 11, wherein the food preparation area includes a plurality of food preparation surfaces, and the at least one retractable hose device comprises a plurality of retractable hose devices for servicing the plurality of food preparation surfaces.

16. A method of cleaning and sanitizing a food preparation area, the method comprising:
providing at least one retractable hose device including a hose and a device for retracting the hose, in proximity to a food preparation area;
providing at least one fluid directing nozzle connected to the hose;
providing a fluid proportioning device connected to the hose;
providing at least one of a cleaning agent and a sanitizing agent to the fluid proportioning device;
connecting a supply of diluent to the fluid proportioning device;
proportioning the at least one of the cleaning agent and the sanitizing agent with the diluent supply using the fluid proportioning device to create at least one of a cleaning solution and a sanitizing solution;
at least partially extending the hose from a retracted position; and
discharging solution through the fluid directing nozzle toward the food preparation area.

17. The method of claim 16, further comprising discharging solution as a spray onto a food preparation surface in the food preparation area.

18. The method of claim 16, further comprising:
providing a tank connected to the proportioning device;
providing a pump connected to the tank and connected to the hose;
dispensing the diluent and the at least one of the cleaning agent and the sanitizing agent into the tank using the proportioning device, wherein the at least one of the cleaning solution and the sanitizing solution exists in the tank; and
transferring the at least one of the cleaning solution and the sanitizing solution from the tank into the hose using the pump.

19. The method of claim 16, wherein the connecting the supply of diluent to the fluid proportioning device comprises connecting a pressurized supply of water to the fluid proportioning device.
